(19) United States
(12) Patent Application Publication
(10) Pub. No.: US 2004/0103249 A1
(43) Pub. Date: May 27, 2004

(54) Memory access over a shared bus

(76) Inventor: Chang-Ming Lin, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/304,386

(22) Filed: Nov. 25, 2002

(51) Int. Cl. G06F 12/00

(52) U.S. Cl. 711/118; 711/147

(57) ABSTRACT

In general, in one aspect, the disclosure describes techniques that can provide a processor with access to memory controllers via logic to receive memory access commands from the processor, allocate buffer(s) for the commands, and send a memory access command to the appropriate memory controller that includes identifier(s) associated with the allocated buffers. After the logic receives a reply from the memory controller, the logic sends the processor data stored in the buffer(s).

### BACKGROUND

In some systems, such as systems having multiple processors, many different agents may share memory resources. Potentially, the different agents may request access to the same memory locations at the same (or nearly the same) time. This can potentially cause unintended affects. For example, one agent may overwrite data written by another.

To provide agents with some control over memory in such an environment, a memory controller or memory may support “atomic” operations that guarantee that an agent's requests will not be affected by requests of other agents during their execution. For example, an atomic “swap” operation combines a read request with a write request. That is, an atomic swap operation retrieves data from memory and writes new data in the retrieved data's place. The swap operation is atomic in that other agents cannot alter the data stored at the memory location(s) while the old data is being read and the new data is being written to the location(s).

### BRIEF DESCRIPTION OF THE DRAWINGS

FIGS. 1-6 are diagrams that illustrate operation of logic to process memory access commands.

FIG. 7 is a flow-chart of a process for processing memory access commands.

FIG. 8 is a diagram of a network processor.

FIG. 9 is a diagram of a network device.

### DETAILED DESCRIPTION

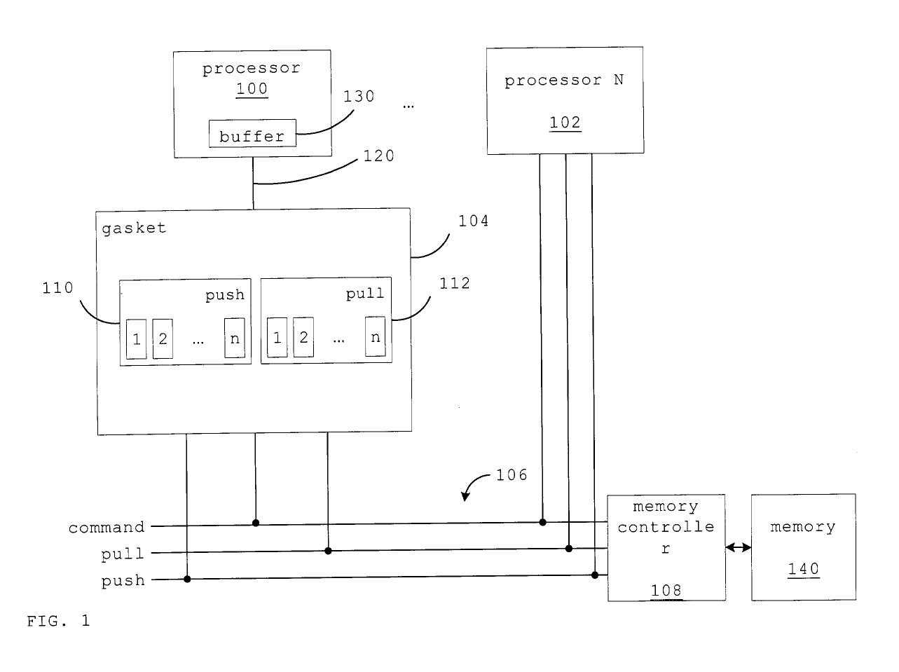

FIG. 1 depicts an example of a system that includes multiple agents (e.g., threads of processors 100, 102) that share memory resources. A memory controller 108 coordinates agent access to a memory device 140 by receiving memory access requests over a bus 106 and subsequently accessing memory 140 to satisfy the requests. Potentially, the memory controller 108 returns information (e.g., in the case of a read request) to the requesting agent.

As shown, a processor 100 may communicate with the memory controller bus 106 via “gasket” logic 104. The gasket 104 communicates with the processor 100 via a first bus 120 and communicates with the memory controller 108 via bus 106. The gasket 104 can perform a variety of operations involved in bridging the different busses 120, 106. For example, the gasket 104 can act as an intermediate between the different command protocols of the first bus 120 and second bus 106 (e.g., handling the different handshaking mechanisms, translating command data to different message formats, and so forth). The gasket 104 may also act as a bridge between different time-domains of the different busses 120, 106. For example, bus 106 may operate at a slower frequency than bus 120. Additionally, the gasket 104 may provide programs executed by the processor 100 with an extended set of memory access commands such as additional atomic commands. The gasket logic may be implemented in a wide variety of ways (e.g., hardware, firmware, software, and/or some combination thereof).

In greater detail, the gasket 104 receives memory access commands from processor 100 over bus 120. As an example, the processor 100 may be a StrongARM® XScale® processor that communicates with the gasket 104 via-an XScale® Core Memory Bus (CMB) using the CMB protocol. A command can include an identification of the target device of the command (e.g., identification of a memory device), identification of the type of command (e.g., a read or write), identification of a memory address to access, an amount of data to access, and, potentially, identification of an XScale buffer 130 to store results of the command.

The gasket 104 may feature a queue (not shown) to store commands received from the processor 100. The queue may act as a bridge between different time domains supported by the gasket 104. For example, gasket 104 components handling a first clock frequency (e.g., 600 MHz for the CMB bus 120) may place commands on the queue while components handling a second clock frequency (e.g., 300 MHz for memory controller bus 106) remove commands from the queue.

The processor 100 can issue a variety of memory access commands such as commands that read data and commands that write data. In the case of an XScale processor, the processor 100 can also request an atomic “swap” by sending a read command that reads data from memory and a write command that stores data in the same location(s). The XScale distinguishes the pair of commands of a “swap” from an otherwise non-atomic pair of successive read/write commands by setting a “lock” flag (e.g., the XScale cbiLock pin) when transmitting the “swap” read/write commands over the bus 120. Though the XScale provides this mechanism to indicate an atomic “swap” command, the gasket 104 can provide additional atomic commands based on characteristics of one or more commands received from the processor 100. For example, the gasket 104 can replace the read and write commands of a swap request with an atomic bit-set or bit-clear command that reads data from the memory and replaces the data with particular bits set or cleared. Similarly, the gasket 104 can replace the read and write commands of the swap with an atomic add or subtract command that reads data from memory and replaces the data plus or minus a specified value. In addition to providing agents with greater control over memory operations, the reduction in the number of commands sent to the memory controller 108 reduces bus 106 traffic.

The gasket 104 can use a variety of techniques to identify a command to use in place of the read/write pair of a “swap”. For example, the gasket 104 can determine a command based on the address specified by a command. For instance, the gasket 104 can divide the virtual memory space of the XScale 100 into n-sections where each section corresponds to a different type of atomic command (e.g., addresses 0 to x correspond to a bit-set command; addresses y to z correspond to a bit-clear command; and so forth). The gasket 104 can then use the address of the read command of a read/write swap pair to determine which kind of atomic command should be issued to the memory controller 108. For example, if the address of the read falls between 0 and x, the gasket 104 can issue an atomic bit-set set command to the memory controller 108 instead of the swap's read/write pair. Similarly, if the address of the read falls between y and z, the gasket 104 can issue an atomic bit-clear command to the memory controller 108. Before issuing a command, the gasket 104 maps the virtual address(es) to the physical address(es) of the memory 140.

As shown, the gasket 104 communicates with the memory controller 108 via a second bus 106. The bus 106 illustrated is an example of a “push/pull” bus 106 that enables the memory controller 108 to pull data being written to memory and to push data read from memory. This “push/pull” mechanism can reduce the amount of data stored by the controller 108. For example, instead of storing data for write commands queued by the controller 108, the controller 108 can request the data when needed. As shown, the bus 106 features independent data lines to simultaneously carry memory access commands and requests to push or pull data.

As shown, the gasket 104 features a collection of buffers 110, 112. These buffers 110, 112 may be divided into “push” buffers 110 that store data pushed by the memory controller 108 to the gasket 104 and “pull” buffers 112 that store data pulled from the gasket 104 by the controller 108. Thus, for a read command, the gasket 104 allocates a push buffer 110, while for a write command, the gasket 104 allocates a pull buffer 112. Likewise for a “swap” command, the gasket 104 can allocate both push 110 and pull 112 buffers. The allocation may be performed in a variety of ways. For example, the gasket 104 may maintain a first-in-first-out (FIFO) pool of available buffers. The pool may be replenished with previously allocated buffers as these buffers are released, e.g., after the completion of a command. Potentially, the buffers may be allocated to different memory controllers and memory (e.g., SRAM and DRAM) attached to the push/pull bus 106 at different times.

To communicate with the memory controller 108, the gasket 104 requests bus access to send a command. After an arbiter (not shown) grants the request, the gasket 104 can send a command to the controller 108 (e.g., a Command Push Pull (CPP) protocol command). The command can include the target of the command, the command type (e.g., load, store, atomic swap, atomic add, atomic subtract, atomic bit-set, and atomic bit-clear), the memory address, and the data length of the request. The command can also include identification of the gasket push 110 and/or pull 112 buffer(s) allocated for the command. For example, the different buffers 110, 112 may be enumerated (as shown) or feature other labels uniquely identifying each buffer 110, 112.

After receiving the command from the gasket 104, the memory controller 108 may subsequently push and/or pull data from the gasket 104. Such requests may be made via independently operating push and pull arbiters that receive the memory controller 108 requests and forward them to the gasket 104. The memory controller 108 requests include identification of the pull/push buffer(s) allocated to the command being processed by the memory controller 108. Upon receipt of the memory controller 108 request, the gasket 104 can access the identified buffer(s) and acknowledge the push or return the data requested by the pull to the controller 108.

The gasket 104 can monitor a push buffer 110 to determine when data has been retrieved. For example, the push buffer 110 may store the number of bytes being retrieved and set a “Ready” flag when the buffer has received the expected amount of data. When the “Ready” flag is set, the gasket 104 can forward the retrieved data to the processor 100 via bus 120. For example, the gasket 104 can send the retrieved data stored in the push buffer along with identification of the processor 100 buffer 130 allocated to store the results.

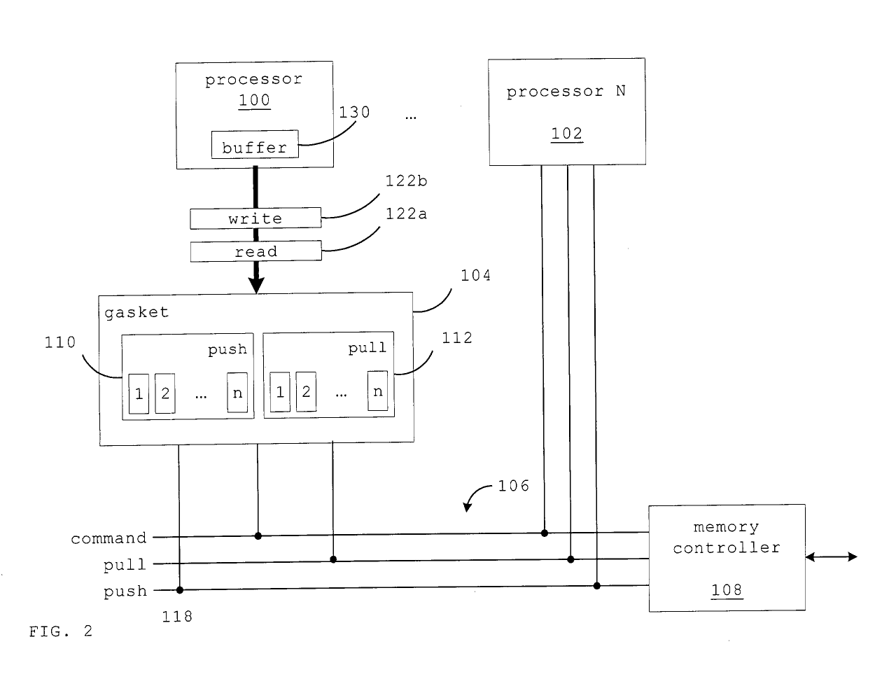

To illustrate operation of the gasket 104, FIGS. 2-6 depict gasket 104 processing of commands issued by the processor 100. As shown in FIG. 2, the gasket 104 receives a read 122a memory access command from the processor 100. The read command 122a may include identification of a processor buffer 130 that will store the results of the command 130. In this example, the processor 100 indicates that the command forms part of an atomic command (e.g., the XScale can set the cbiLock flag). Thus, the gasket 104, instead of queuing the read command 122a for processing, awaits the paired write command 122b and determines if the commands 122 should be “aliased” (replaced with a different command). Again, the aliasing may be performed using a variety of techniques including the memory mapping technique described above.

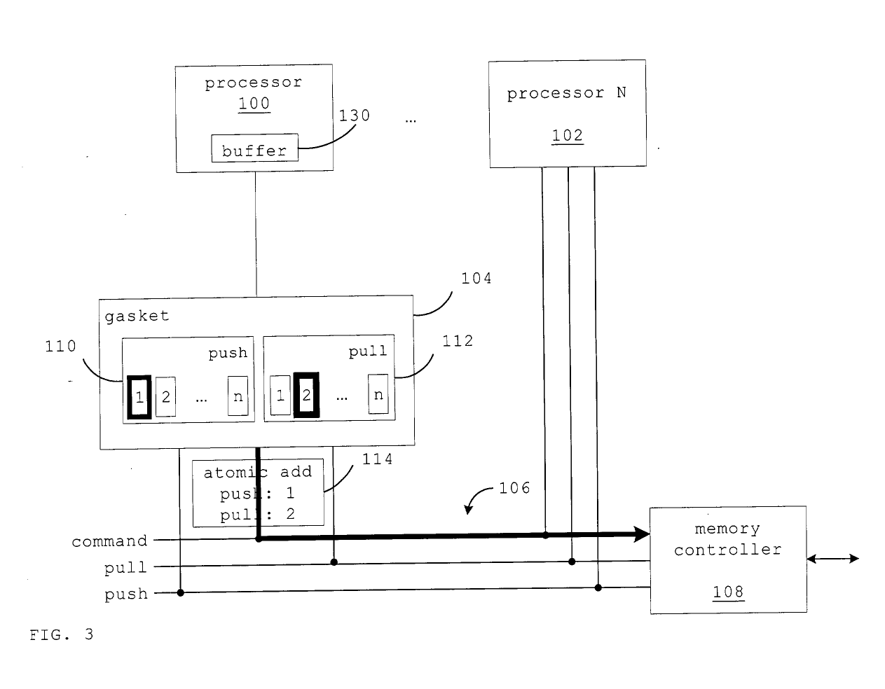

As shown in FIG. 3, in the example, the read 122a and write 122b commands are replaced by an atomic add command 114. The gasket 104 allocates push buffer “1” and pull buffer “2” (bolded) for the command and fills the allocated pull 112 buffer with data used by the add command 114 (e.g., the amount to add). The gasket 104 initializes the push 110 buffer to include the expected data length of the operation, resets the push buffer's “Ready” flag, and stores identification of the buffer 130 allocated by the processor 100 to store command results. The gasket 104 then requests access to the command lines of the push/pull bus 106 and transmits the atomic add command 114 to the controller 108 with the identifiers of the allocated push/pull buffers.

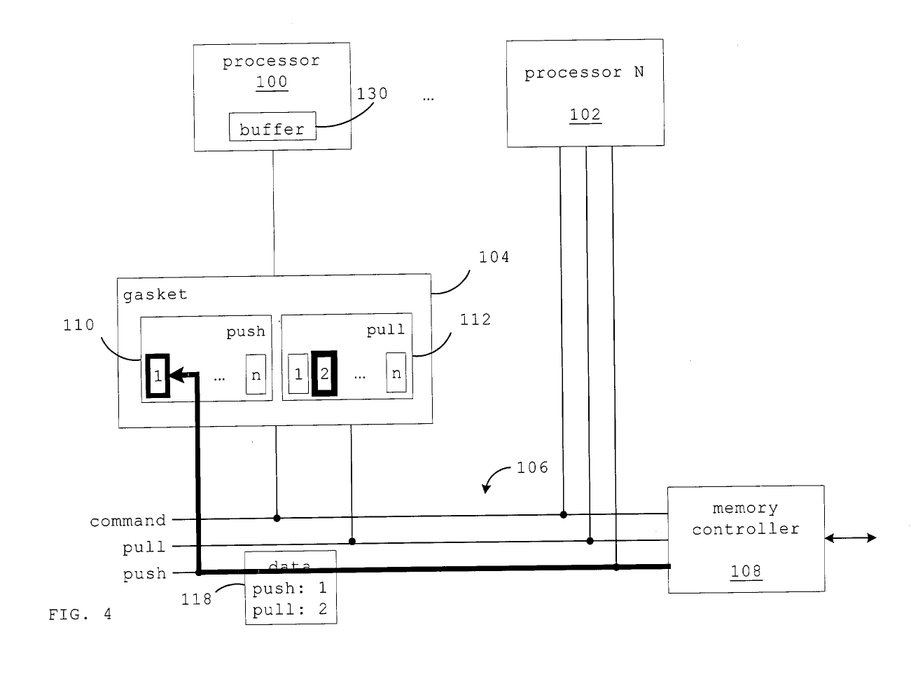

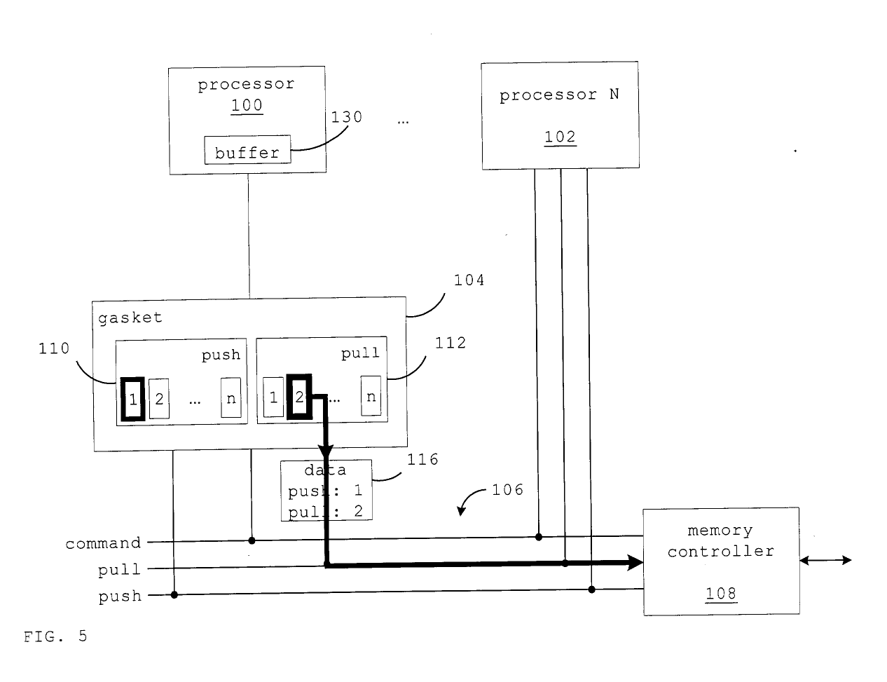

As shown in FIGS. 4 and 5, the memory controller 108 pushes 118 and pulls 116 data to and from the gasket 104. In this example of an atomic add command, the memory controller 108 pulls data being added and pushes data read from memory. Depending on the length of data being operated on, the controller 108 may initiate multiple pushes and pulls. The controller 108 push and pulls include identification of the gasket 104 push/pull buffers allocated to the command. The gasket 104 uses these identifiers to access the appropriate buffers to satisfy the controller 108 push/pull requests. The buffer identifiers may be “opaque data” to the controller 108. That is, the controller 108 merely receives and returns the identifiers.

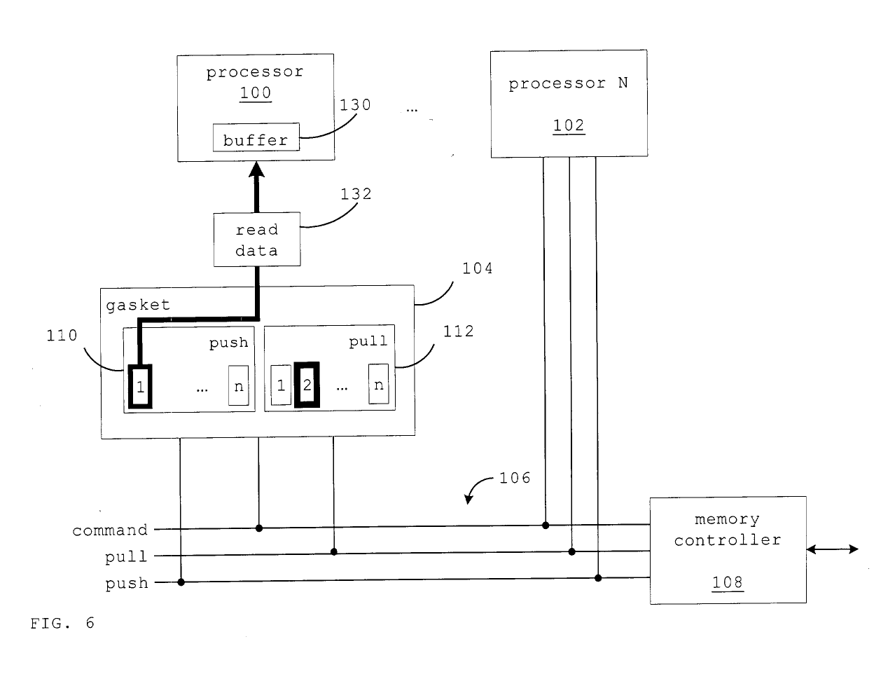

As shown in FIG. 6, after a push buffer 110 receives the expected data, the gasket 104 transmits the pushed data to the processor 100 along with the identification of the processor 100 buffer 130 storing results of the command. While the sequence of FIGS. 5 and 6 depict transmission of results to the processor 100 after the pull (FIG. 5), transmission of results to the processor 100 may occur before the pull occurs (e.g., immediately after the push (FIG. 4)).

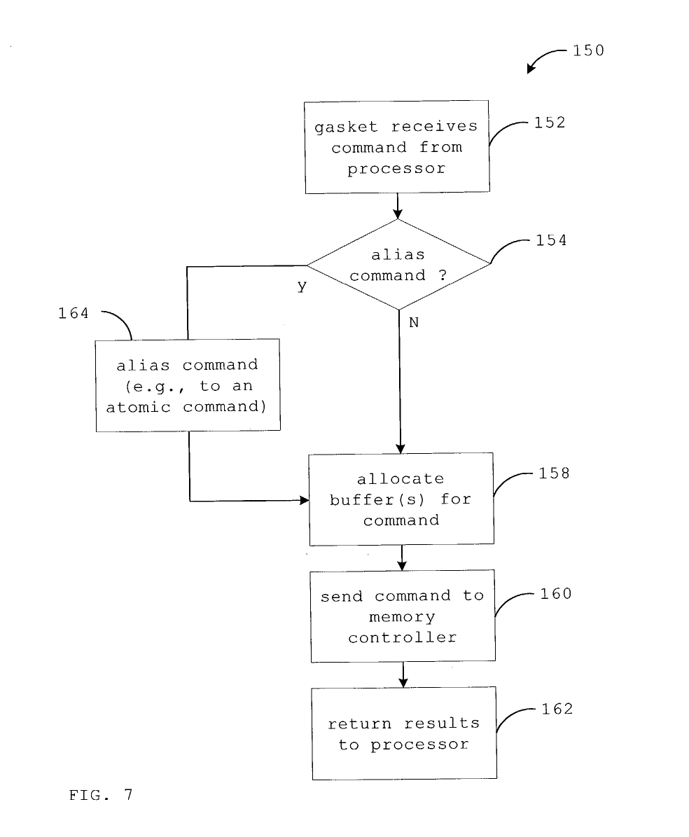

FIG. 7 illustrates a gasket 104 process 150 for handling processor memory access commands using techniques described above. As shown, after receiving 152 one or more commands, the process 150 determines 154 if the command(s) should be aliased. If so, the process determines 164 the alias command. The process 150 allocates 158 one or more buffers for the command, and sends 160 the command to a memory controller with identification of the allocated buffers. Potentially, depending on the amount of memory being accessed, the process 150 may generate multiple commands that access subsets of the memory being accessed (e.g., a command to read n-bytes may be divided into two commands that each read n/2-bytes). After receiving results of the command along with identification of the buffer(s) allocated to store the results, the process 150 stores the results in the allocated buffer and forwards 162 the results to the processor.

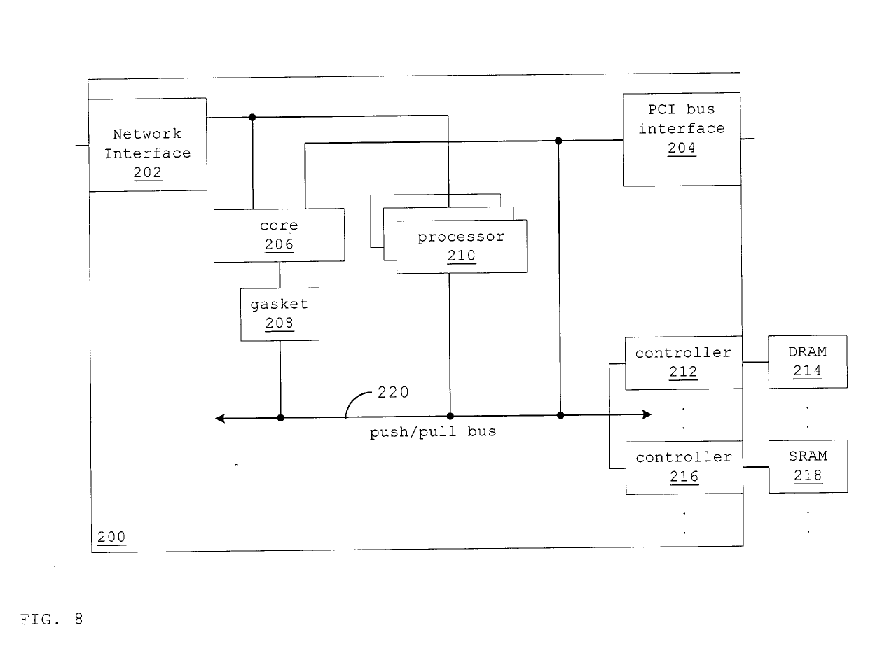

The techniques described above may be used in a wide variety of environments. For example, FIG. 8 depicts a sample architecture of a network processor. The processor 200 shown is an Intel® Internet eXchange network Processor (IXP). Other network processors feature different designs.

The processor 200 shown features a network interface 202 (e.g., a UTOPIA/POS interface (Universal Test and Operational PHY Interface for ATM/Packet-Over-SONET), an interface to a switch fabric, and so forth) that enables the processor 200 to send and receive data over a network. The processor 200 also includes an interface 204 for communicating with a host or other local devices. Such an interface 204 may be a Peripheral Component Interconnect (PCI) type interface such as a PCI-X bus interface.

The processor 200 shown also features a collection of packet processors 210. In an IXP, the packet processors 210 are Reduced Instruction Set Computing (RISC) processors tailored for processing network packets. For example, the processors do not include floating point instructions or instructions for integer multiplication or division commonly provided by general purpose central processing units (CPUs). An individual packet processor 210 offers multiple threads. The multi-threading capability of the processors 210 is supported by hardware that can quickly swap context data for the different threads between context registers and context storage.

The processor 200 also includes a core processor 206 (e.g., an XScale) that is often programmed to perform “control plane” tasks involved in network operations. The core processor 206, however, may also handle “data plane” tasks and may provide additional packet processing threads.

As shown the network processor 200 features memory controllers 212, 216 that offer access to dynamic random access memory (DRAM) 214 and static random access memory (SRAM) 218. The network processor 200 may also include other memory resources such as scratchpad memory (not shown). The memory 214, 216 stores a wide variety of information used in packet processing such as lookup tables, packet payloads, packet headers, and so forth.

The packet processors 210, core 206, and the PCI interface 204 can access the different memory devices 214, 218 via shared bus 220. For example, as shown, the packet processors 210 connect to a push/pull bus 220 connecting the different agents 210, 206, 204 and memory devices 214, 218. The core 206 also connects to the push/pull bus 220 of memory controller 216 via gasket 208. Thus, the controller 216 may receive requests from a number of different agents (e.g., different threads operating on the processors 210, core 206, and remote agents via the PCI interface 204). Again, the gasket 208 can perform the techniques described above to, for example, extend the memory access commands available to the core 206 and/or allocate buffers for use in handling memory access command data.

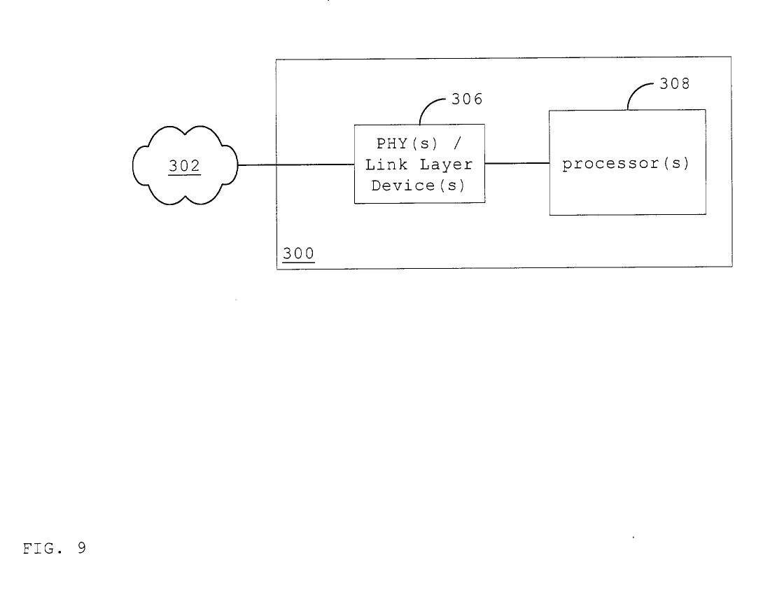

FIG. 9 depicts a network device 300 that can implement the memory access techniques described above. As shown, the network device 300 features one or more processors 308 (e.g., the network processor shown in FIG. 8) that can perform packet processing operations such as packet classification, verification, and forwarding. The processors 308 communicate with a network 302 via one or more physical layer (PHY) devices (e.g., devices handling transmission over optical, copper, and/or wireless links) and link layer devices. 306. For example, the device 300 may include a Universal Test and Operation PHY interface over ATM (UTOPIA), an Ethernet medium access control (MAC) device, a Synchronous Optical Network (SONET) framer, and so forth). The device 300 may be programmed or designed to perform a wide variety of network duties such as routing, switching, bridging, acting as a firewall, and so forth.

Other embodiments are within the scope of the following claims.

What is claimed is:

1. An apparatus, comprising:
at least one processor;
at least one memory controller;
logic coupled to at least one of the at least one processors via a first bus and at least one of the at least one memory controllers via a second bus, the logic to:
receive at least one memory access command from a one of the at least one processors via the first bus;
allocate at least one buffer for the at least one memory access command, the at least one buffer having an associated identifier; and
send a memory access command to the at least one memory controller via the second bus with the associated identifier;
receive a reply from the at least one memory controller including the associated identifier; and
send data to the processor stored in the at least one buffer.

2. The apparatus of claim 1, wherein the logic to send a memory access command to the at least one memory controller comprises logic to send an atomic command.

3. The apparatus of claim 2, wherein the atomic command comprises at least one of the following: a bit set command, a bit clear command, an add command, a subtract command, and a swap command.

4. The apparatus of claim 2, wherein the at least one buffer comprises multiple buffers having associated identifiers, wherein at least one of the multiple buffers comprises a buffer to store data being written to memory and wherein at least one of the multiple buffers comprises a buffer to store data being read from memory.

5. The apparatus of claim 1, wherein the logic comprises logic to interface with the first bus using a first bus protocol and logic to interface with the second bus using a second bus protocol different than the first bus protocol.

6. The apparatus of claim 1, wherein the logic comprises logic to interface with the first bus at a first clock rate and logic to interface with the second bus at a second clock rate different than the first clock rate

7. The apparatus of claim 1, wherein the at least one processor comprises multiple processors.

8. The apparatus of claim 1, wherein the logic further comprises logic to store in the at least one buffer data identifying an amount of data to be received for the memory access command sent to the at least one memory controller.

9. The apparatus of claim 1, wherein the logic further comprises logic to:
receive identification of storage to store results of the at least one memory access command received from the processor;
store the received identification of storage; and
wherein the logic to send data to the processor comprises logic to send the received identification of storage.

10. The apparatus of claim 1, wherein the second bus comprises a push/pull bus.

11. A method, comprising:
receiving at least one memory access command from a processor via a first bus;
allocating at least one buffer for the at least one memory access command, the at least one buffer having an associated identifier; and
sending a memory access command to a memory controller via a second bus with the associated identifier of the at least one buffer;
receiving a reply from the at least one memory controller including the associated identifier;
storing data included in the reply in the buffer corresponding to the associated identifier; and
sending data stored in the at least one buffer to the processor.

12. The method of claim 11, wherein the sending the memory access command comprises sending an atomic memory access command.

13. The method of claim 12, wherein the atomic command comprises at least one of the following: a bit set command, a bit clear command, an add command, a subtract command, and a swap command.

14. The method of claim 11, wherein the at least one buffer comprises multiple buffers having associated identifiers, wherein at least one of the multiple buffers comprises a buffer to store data being written to memory and wherein at least one of the multiple buffers comprises a buffer to store data being read from memory.

15. The method of claim 11, further comprising storing in the at least one buffer data identifying the amount of data to be received from the memory.

16. The method of claim 11, further comprising:
receiving identification of storage to store results of the at least one memory access command;
storing the received identification of processor storage; and
wherein the sending data to the processor comprises sending the received identification of processor storage.

17. The method of claim 11, wherein the second bus comprises a push/pull bus.

18. A network device, comprising:
at least one network processor, the network processor comprising:
more than one processor;
more than one memory controller;
a first bus accessed by the more than one processors, the bus coupled to the more than one memory controller; and
logic coupled to at least one of the more than one processors via a second bus and coupled to the memory controllers via the first bus, the logic to:
receive at least one memory access command from a one of the at least one processors via the second bus;
allocate at least one buffer for the at least one memory access command, the at least one buffer having an associated identifier; and
send a memory access command to a memory controller via the first bus with the associated identifier of the at least one buffer;
receive a reply from the memory controller including the associated identifier of the at least one buffer; and
send to the one of the at least one processors data stored in the at least one buffer; and
at least one optical PHY to send and receive data over a optical network.

19. The device of claim 18, wherein the logic to send a memory access command comprises logic to send at least one of the following: an atomic bit set command, an atomic bit clear command, an atomic add command, an atomic subtract command, and an atomic swap command.

20. The device of claim 18, wherein the at least one buffer comprises multiple buffers having associated identifiers, wherein at least one of the multiple buffers comprises a buffer to store data being written to memory and wherein at least one of the multiple buffers comprises a buffer to store data being read from memory.

21. The device of claim 18, wherein the logic further comprises logic to store in the at least one buffer data identifying the amount of data to be received from the memory.

22. The device of claim 18, wherein the logic further comprises logic to:
receive identification of storage to store results of the at least one memory access command;
store the received identification of storage; and
wherein the logic to send data to the processor comprises logic to send the received identification of processor storage.

23. The device of claim 18, wherein the first bus comprises a push/pull bus.
